(19) United States
(12) Patent Application Publication
(10) Pub. No.: US 2003/0113085 A1
(43) Pub. Date: Jun. 19, 2003

(54) HDP-CVD film for uppercladding application in optical waveguides

(75) Inventor: Hichem M'Saad, Santa Clara, CA (US)

Correspondence Address: APPLIED MATERIALS, INC., 2881 SCOTT BLVD. M/S 2061, SANTA CLARA, CA, 95050, US

(73) Assignee: Applied Materials, Inc., a Delaware Corporation, Santa Clara, CA (US)

(21) Appl. No.: 10/017,033

(22) Filed: Dec. 14, 2001

(51) Int. Cl. G02B 6/10; C03B 37/018

(52) U.S. Cl. 385/129; 65/413; 65/386

(57) ABSTRACT

An optical waveguide is formed on a substrate by first depositing an undercladding layer over the substrate. At least one core is formed over the undercladding layer. An uppercladding layer is then formed over the cores with a high-density plasma process. Deposition of the uppercladding layer may proceed by flowing an oxygen-containing gas, such as O₂, a silicon-containing gas, such as SiH₄, and a fluorine-containing gas, such as SiF₄, into a process chamber to produce a gaseous mixture. A high-density plasma, i.e. having a density of at least 10¹¹ ions/cm³, is generated from the gaseous mixture and then used to deposit a fluorinated silicate glass layer.

### CROSS REFERENCE TO RELATED APPLICATION

This application is related to commonly assigned and concurrently filed U.S. Pat. Appl. No. ______ entitled “METHOD OF MANUFACTURING AN OPTICAL CORE,” by Hichem M'Saad (Attorney Docket Number A6123/T43700), the entire disclosure of which is herein incorporated by reference for all purposes.

### BACKGROUND OF THE INVENTION

The internet and data communications are causing a generally increasing demand for bandwidth. Fiber-optic telecommunications systems are currently deploying a relatively new technology called dense wavelength division multiplexing (“DWDM”) to expand the capacity of new and existing optical fiber systems to help satisfy this demand. In DWDM, multiple wavelengths of light simultaneously transport information through a single optical fiber. Each wavelength operates as an individual channel carrying a stream of data. The carrying capacity of a fiber is multiplied by the number of DWDM channels used.

The general structure of an optical fiber 1, shown in FIG. 1, comprises two principal components: a core 3 and a cladding layer 2. The core 3 is the inner part of the fiber through which light is guided and typically has a diameter of about 7 μm. It is surrounded completely by the cladding layer 2, which generally has a lower refractive index so that a light ray 5 in the core 3 that strikes the core/cladding boundary at a glancing angle is confined within the core 3 by total internal reflection. The confinement angle θ_{c} represents an upper limit for the angle at which the light ray 5 can strike the boundary and be confined within the core 3.

Because of the need to maintain total internal reflection, the quality of optical fibers is highly dependent on the variation of refractive indices in the cladding layers and cores. There is accordingly a persistent need in the industry for the development of fabrication techniques that can produce optical waveguides with robust refractive-index characteristics. After such optical waveguides are formed on a substrate, they are cut and connected with an optical fiber for use in, for example, optical add-drop multiplexing and wavelength-selective cross-connect applications.

### SUMMARY OF THE INVENTION

Accordingly, embodiments of the invention provide a method for forming an optical waveguide that make use of high-density plasma processing techniques. The inventor has discovered, despite the sharp difference between the integrated-circuit and optical-telecommunications industries, that certain high-density plasma processing techniques may be profitably adapted to the fabrication of optical waveguides. Rather than focussing on electrical characteristics, as is typical in the integrated-circuit industry, embodiments of the invention result in improvements in the optical characteristics of structures.

In one embodiment, the optical waveguide is formed on a substrate by first depositing an undercladding layer over the substrate. At least one core is formed over the undercladding layer. An uppercladding layer is then formed over the cores with a high-density plasma process. Deposition of the uppercladding layer may proceed by flowing an oxygen-containing gas, such as O₂, and a silicon-containing gas, such as SiH₄, into the process chamber to produce a gaseous mixture. A high-density plasma, i.e. having a density of at least 10¹¹ ions/cm³, is generated from the gas and then used to deposit a silicate glass layer. In a particular embodiment, the flow rate of the oxygen-containing gas is more than 1.8 times the flow rate of the silicon-containing gas. Suitable flow rates for the oxygen-containing gas may be>175 sccm and suitable flow rates for the silicon-containing gas may be between 80 and 110 sccm.

In some embodiments, the refractive index of the silicate glass layer may be adjusted by also flowing a fluorine-containing gas, such as SiF₄. In one particular embodiment, a suitable flow rate for the fluorine-containing gas is between 10 and 20 sccm. Further tuning of the refractive index may be achieved by also flowing a boron-containing gas, such as BF₃, which may also be used for reducing the stress of the layer. In another particular embodiment, a suitable flow rate for the boron-containing gas is 0 to 20 sccm. The stress of the uppercladding layer may be reduced by also flowing a phosphorus-containing gas, such as PH₃. In yet another particular embodiment, a suitable flow rate for the phosphorus-containing gas is 0 to 30 sccm. In one embodiment, an RF source power is applied to the process chamber with a power density between 6 and 30 W/cm². In another embodiment, an RF bias power is applied to the substrate with a power density between 0 and 16 W/cm². According to embodiments of the invention, an uppercladding layer may be provided in optical waveguides with the desired index of refraction of 1.4443-1.4473 at 1550 nm (corresponding to a refractive index of 1.4569-1.4599 at a wavelength of 633 nm).

The methods of the present invention may be embodied in a computer-readable storage medium having a computer-readable program embodied therein for directing operation of substrate processing system. Such a system may include a process chamber, a plasma generation system, a substrate holder, a gas delivery system, and a system controller. The computer-readable program includes instructions for operating the substrate processing system to form an optical waveguide on a substrate disposed in the processing chamber in accordance with the embodiments described above.

A further understanding of the nature and advantages of the present invention may be realized by reference to the remaining portions of the specification and the drawings.

### BRIEF DESCRIPTION OF THE DRAWINGS

FIG. 1 is a cross-sectional view of an optical fiber illustrating the use of total internal reflection;

FIG. 2 is a cross-sectional view of an optical waveguide deposited with flame hydrolysis deposition;

FIG. 3 is a cross-sectional view of an optical waveguide having an undercladding layer and an uppercladding layer;

FIG. 4A is a simplified diagram of one embodiment of a high-density plasma chemical vapor deposition system according to the present invention.

FIG. 4B is a simplified cross section of a gas ring that may be used in conjunction with the exemplary CVD processing chamber of FIG. 4A.

FIG. 4C is a simplified diagram of a monitor and light pen that may be used in conjunction with the exemplary CVD processing chamber of FIG. 4A.

FIG. 4D is a flow chart of an exemplary process control computer program product used to control the exemplary CVD processing chamber of FIG. 4A;

FIGS. 5 is a flow diagram illustrating one embodiment of the invention for fabricating an optical waveguide;

FIG. 6 is a Fourier-transform infrared spectrum of an uppercladding layer deposited in accordance with the invention;

FIG. 7 is a graphical representation of the refractive-index dependence on the O₂ flow rate in one embodiment of the invention;

FIG. 8 is a graphical representation of the refractive-index dependence on the SiF₄ flow rate in one embodiment of the invention; and

FIG. 9 shows the effect on refractive index of thermally annealing an uppercladding layer deposited in accordance with an embodiment of the invention.

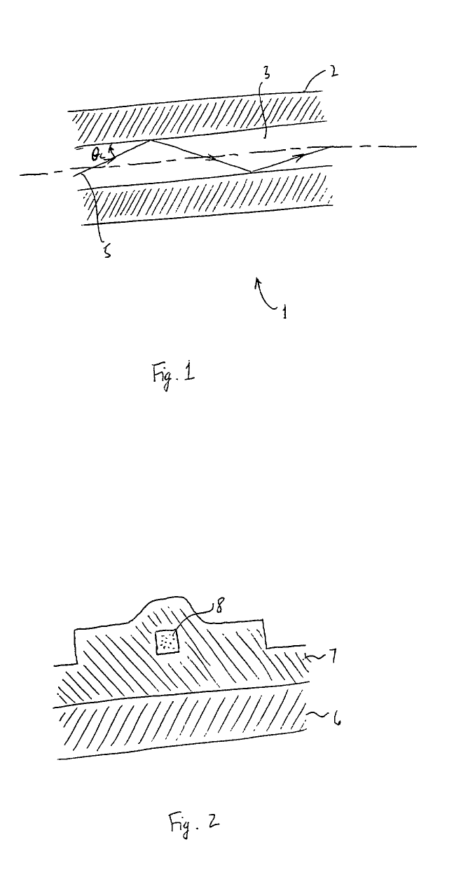

### DETAILED DESCRIPTION OF THE INVENTION

1. Introduction

According to embodiments of the invention, a high-density-plasma (“HDP”) process is used for depositing an uppercladding layer in an optical waveguide. As used herein, a “high-density plasma” is understood to have an ion density that is equal to or exceeds 10¹¹ ions/cm³.

A particular concern with other fabrication techniques for producing optical waveguides is that there may be a tendency for the structures to crack. For example, one fabrication technique that could be used is flame hydrolysis deposition. A cross-sectional view of a conventional optical waveguide formed on a Si substrate 6 is shown in FIG. 2. In flame hydrolysis deposition, undoped silica could be used for the cladding layer 7 and a high-refractive-index material used for the core 8, in which dopants such as germanium, titanium, or boron+phosphorus are introduced. To make the silica optically transparent would require a thermal treatment at a temperature of about 1500° C. after silica powder has been deposited on the substrate 6. Such a thermal treatment, however, would tend to generate cracks in the layers as a result of thermal strains.

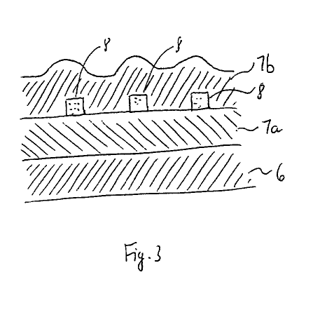

To mitigate the thermal strain, it is instead possible to reduce the amount of material that requires thermal annealing by depositing both an undercladding layer 7a and an uppercladding layer 7b, as shown in cross-section view in FIG. 3. In a specific embodiment, the undercladding layer 7a is formed of undoped SiO₂ (“USG”), but more generally, the undercladding layer 7a may be formed from any material having a lower refractive index than the core 8. The undercladding layer 7a is typically a thermal oxide or a high-pressure oxide. FIG. 3 shows how a plurality of cores 8 may be formed so that a plurality of optical waveguides may be fabricated simultaneously. It will be appreciated that including a plurality of cores 8 requires that the gaps between them be filled as fully as possible with appropriate gapfilling techniques.

The uppercladding layer will generally have a thickness between 10 and 20 μm. At a wavelength of 1550 nm, which is midway in the currently used optical telecommunications wavelength range of 1530-1570 nm, the refractive index of the uppercladding layer should be between 1.4443 and 1.4473. This refractive index corresponds to a range of 1.4569-1.4599 at He-Ne-laser wavelengths of 633 nm, and should match the refractive index of the undercladding layer. Since the refractive index of undoped CVD oxide remains above 1.46, the uppercladding layer is doped to reduce its refractive index.

The inventor has discovered that by using certain high-density plasma processes to deposit the uppercladding layer, it is possible to avoid annealing, resulting in a simplification of the process flow, increased throughput, reduced cost, and improved homogeneity of the uppercladding layer. In addition, better control of the device characteristics is achieved. High-density plasma processes have previously been limited primarily to semiconductor processing, where the principal concern is the electrical properties of materials, usually characterized by the dielectric constant. In contrast, the application of high-density plasma processes to the present invention is concerned more with optical properties and the desire to have such optical properties be as uniform as possible.

In one embodiment, such a high-density plasma process uses chemical vapor deposition (“HDP-CVD”) while in another embodiment, it uses electron cyclotron resonance (“HDP-ECR”). Other CVD-type processes for depositing the uppercladding layer, such as standard, capacitively-coupled plasma-enhanced CVD (“PECVD”), atmospheric-pressure CVD (“APCVD”), and sub-atmospheric-pressure CVD (“SACVD”), all would continue to require annealing. This is because the SiO_{X} in such processes would typically be doped with (1) boron to flow the oxide so that gaps between the cores 8 may be gapfilled and (2) phosphorus to tune the refractive index to the desired value. Borophosphosilicate glasses (“BPSG”) deposited with any of PECVD, APCVD, and SACVD contain a high quantity of hydrogen and are tensile. As a result, annealing would typically be needed, for example, at 1000-1100 ° C. for 1-2 hours after a thickness of about 2 μm was deposited. Not only does annealing permit outdiffusion of dopants from the cores 8, thereby undesirably affecting the refractive index of the cladding, the need for periodic interruption of the deposition results in a multilayer structure for which the refractive index must be matched for the different layers.

According to embodiments of the invention, fluorine-doped silicate glass is deposited as the uppercladding layer with an HDP-CVD (or HDP-ECR) technique. High plasma density has the benefit of providing oxides for deposition that are dense and contain low impurities levels, particularly for hydrogen. The HDP processes do not require a reflow to gapfill since sufficient gapfill is provided by the inherent sputtering component in the deposition process. Fluorine doping is used in one embodiment because fluorine has a lower polarizability than oxygen so that fluorine incorporation reduces the refractive index of the undoped oxide from 1.46 to the required specification of the uppercladding layer.

An advantage of using deposition of fluorine-doped HDP oxides to fabricate optical-waveguide structures is that developments from the semiconductor industry may be adapted. Fluorine-doped HDP oxides have been used in the semiconductor industry as first-generation low-dielectric-constant material for intermetal dielectric applications in logic devices and embedded memories in the 0.18-μm generation node and others. The unexpected ability to adapt such semiconductor-processing developments to optical applications means that embodiments of the invention may readily be adapted to production-scale levels. Fluorine doping has the added benefit of reducing the film's hydrogen content, which is known to be a light-scattering center at telecommunications wavelengths of 1530-1570 nm, by scavenging the hydrogen from silane precursors.

2. Exemplary HDP Substrate Processing System

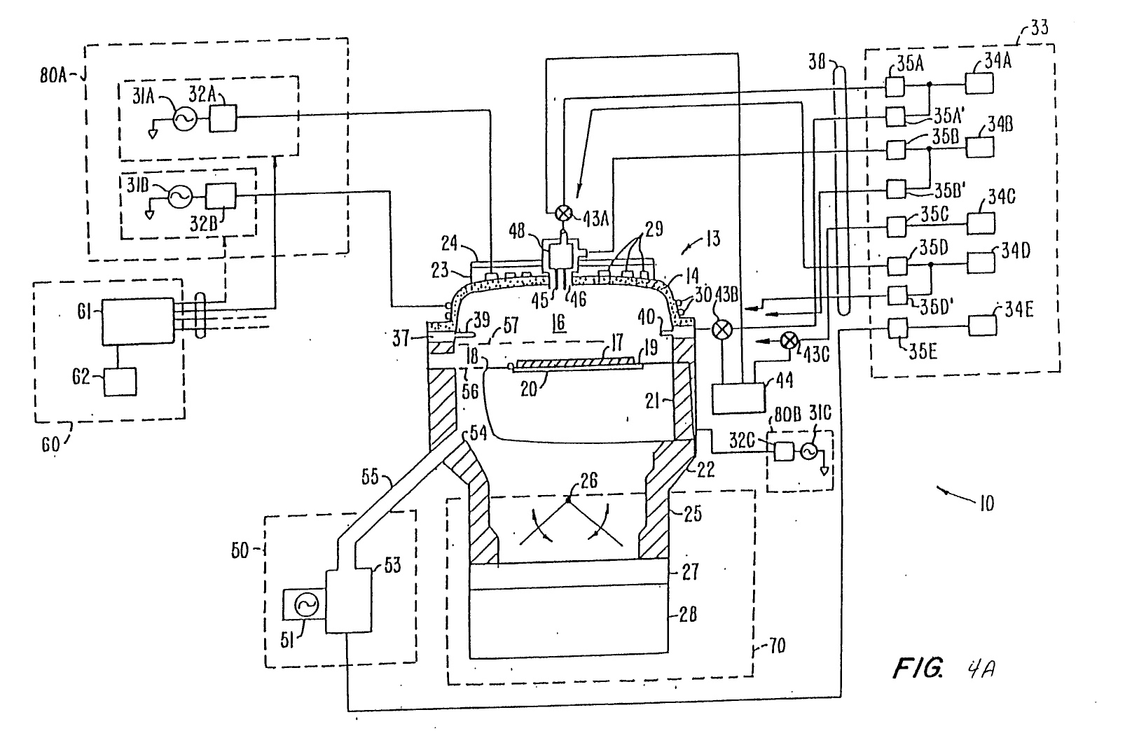

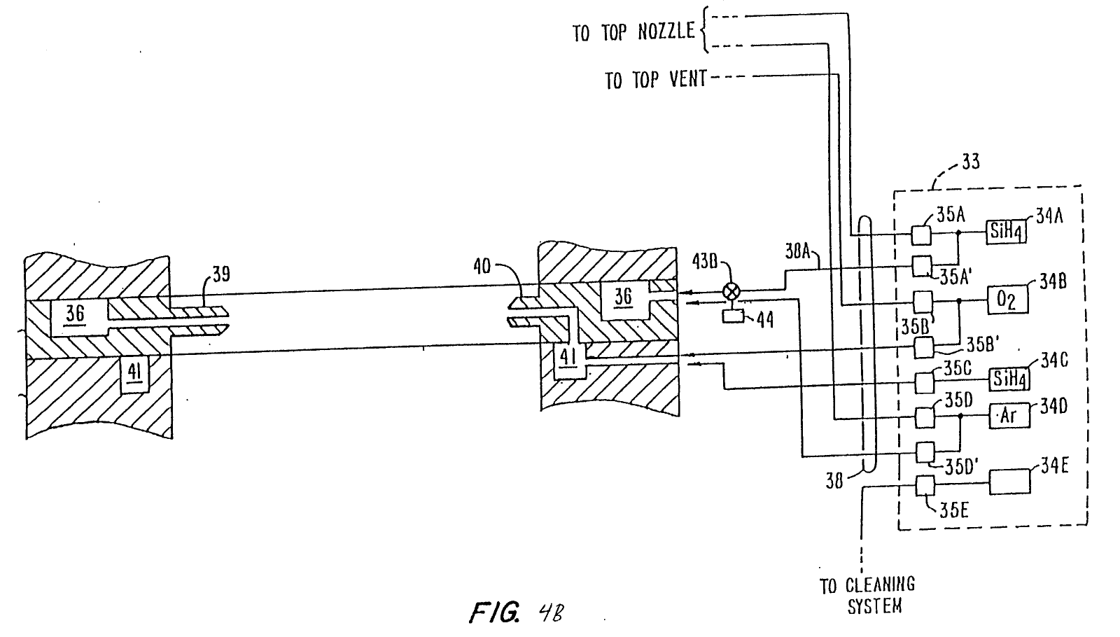

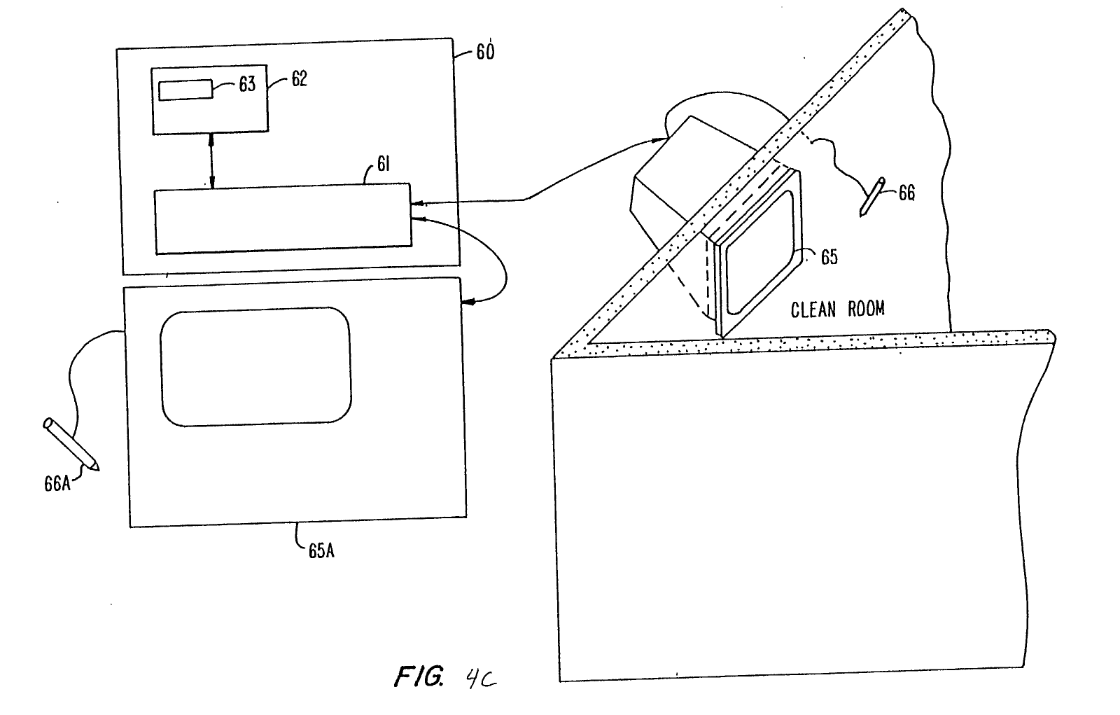

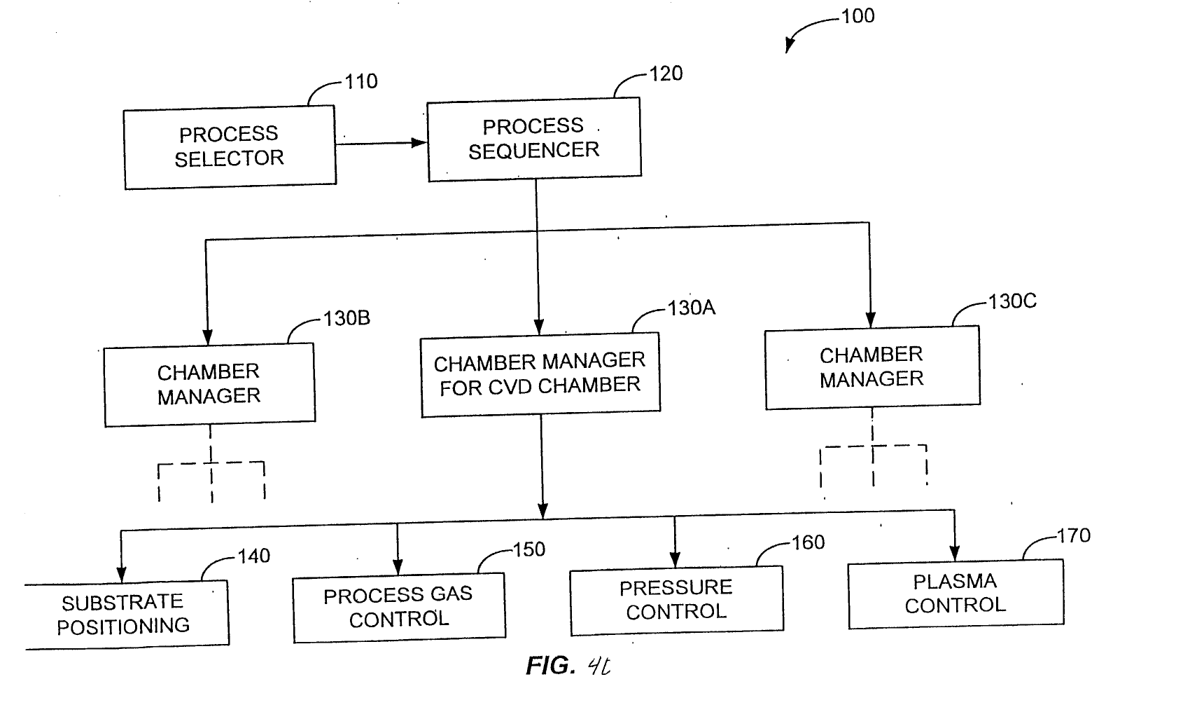

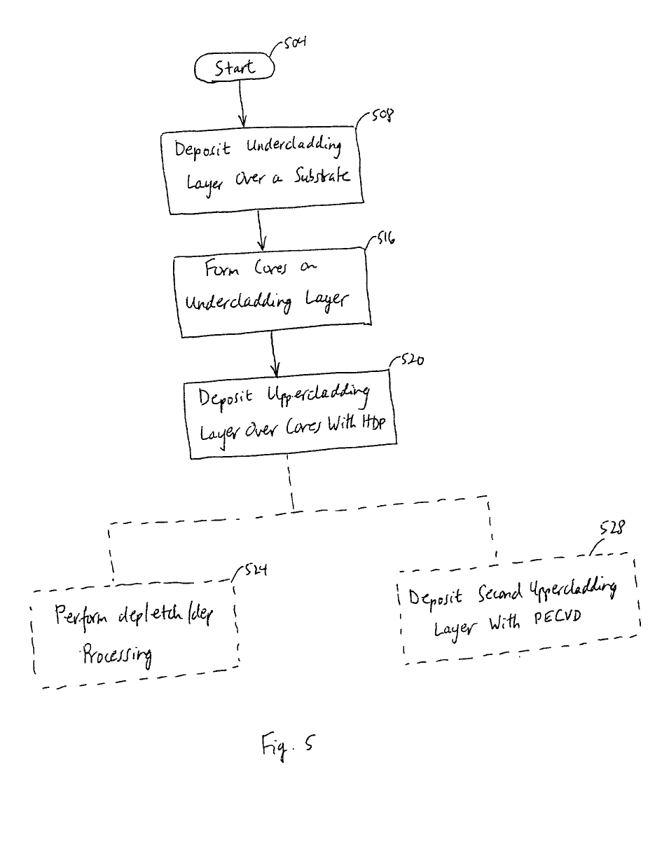

FIG. 4A illustrates one embodiment of a high density plasma substrate processing system 10 in which an optical waveguide, including an uppercladding layer according to the present invention, can be formed. System 10 includes a chamber 13, a vacuum system 70, a source plasma system 80A, a bias plasma system 80B, a gas delivery system 33, and a remote plasma cleaning system 50.

The upper portion of chamber 13 includes a dome 14, which is made of a ceramic dielectric material, such as aluminum oxide or aluminum nitride. Dome 14 defines an upper boundary of a plasma processing region 16. Plasma processing region 16 is bounded on the bottom by the upper surface of a substrate 17 and a substrate support member 18.

A heater plate 23 and a cold plate 24 surmount, and are thermally coupled to, dome 14. Heater plate 23 and cold plate 24 allow control of the dome temperature to within about ±10° C. over a range of about 100° C. to 200° C. This allows optimizing the dome temperature for the various processes. For example, it may be desirable to maintain the dome at a higher temperature for cleaning or etching processes than for deposition processes. Accurate control of the dome temperature also reduces the flake or particle counts in the chamber and improves adhesion between the deposited layer and the substrate.

The lower portion of chamber 13 includes a body member 22, which joins the chamber to the vacuum system. A base portion 21 of substrate support member 18 is mounted on, and forms a continuous inner surface with, body member 22. Substrates are transferred into and out of chamber 13 by a robot blade (not shown) through an insertion/removal opening (not shown) in the side of chamber 13. Lift pins (not shown) are raised and then lowered under the control of a motor (also not shown) to move the substrate from the robot blade at an upper loading position 57 to a lower processing position 56 in which the substrate is placed on a substrate receiving portion 19 of substrate support member 18. Substrate receiving portion 19 includes an electrostatic chuck 20 that secures the substrate to substrate support member 18 during substrate processing. In a preferred embodiment, substrate support member 18 is made from an aluminum oxide or aluminum ceramic material.

Vacuum system 70 includes throttle body 25, which houses twin-blade throttle valve 26 and is attached to gate valve 27 and turbo-molecular pump 28. It should be noted that throttle body 25 offers minimum obstruction to gas flow, and allows symmetric pumping. Gate valve 27 can isolate pump 28 from throttle body 25, and can also control chamber pressure by restricting the exhaust flow capacity when throttle valve 26 is fully open. The arrangement of the throttle valve, gate valve, and turbo-molecular pump allow accurate and stable control of chamber pressures from between about 1 millitorr to about 2 torr.

The source plasma system 80A includes a top coil 29 and side coil 30, mounted on dome 14. A symmetrical ground shield (not shown) reduces electrical coupling between the coils. Top coil 29 is powered by top source RF (SRF) generator 32A, whereas side coil 30 is powered by side SRF generator 32B, allowing independent power levels and frequencies of operation for each coil. This dual coil system allows control of the radial ion density in chamber 13, thereby improving plasma uniformity. Side coil 30 and top coil 29 are typically inductively driven, which does not require a complimentary electrode. In a specific embodiment, the top source RF generator 32A provides up to 2,500 watts of RF power at nominally 2 MHz and the side source RF generator 32B provides up to 5,000 watts of RF power at nominally 2 MHz. The operating frequencies of the top and side RF generators may be offset from the nominal operating frequency (e.g. to 1.7-1.9 MHz and 1.9-2.1 MHz, respectively) to improve plasma-generation efficiency.

A bias plasma system 80B includes a bias RF (“BRF”) generator 32C and a bias matching network 32C. The bias plasma system 80B capacitively couples substrate portion 17 to body member 22, which act as complimentary electrodes. The bias plasma system 80B serves to enhance the transport of plasma species (e.g., ions) created by the source plasma system 80A to the surface of the substrate. In a specific embodiment, bias RF generator provides up to 5,000 watts of RF power at 13.56 MHz.

RF generators 32A and 32B include digitally controlled synthesizers and operate over a frequency range between about 1.8 to about 2.1 MHz. Each generator includes an RF control circuit (not shown) that measures reflected power from the chamber and coil back to the generator and adjusts the frequency of operation to obtain the lowest reflected power, as understood by a person of ordinary skill in the art. RF generators are typically designed to operate into a load with a characteristic impedance of 50 ohms. RF power may be reflected from loads that have a different characteristic impedance than the generator. This can reduce power transferred to the load. Additionally, power reflected from the load back to the generator may overload and damage the generator. Because the impedance of a plasma may range from less than 5 ohms to over 900 ohms, depending on the plasma ion density, among other factors, and because reflected power may be a function of frequency, adjusting the generator frequency according to the reflected power increases the power transferred from the RF generator to the plasma and protects the generator. Another way to reduce reflected power and improve efficiency is with a matching network.

Matching networks 32A and 32B match the output impedance of generators 32A and 32B with their respective coils 29 and 30. The RF control circuit may tune both matching networks by changing the value of capacitors within the matching networks to match the generator to the load as the load changes. The RF control circuit may tune a matching network when the power reflected from the load back to the generator exceeds a certain limit. One way to provide a constant match, and effectively disable the RF control circuit from tuning the matching network, is to set the reflected power limit above any expected value of reflected power. This may help stabilize a plasma under some conditions by holding the matching network constant at its most recent condition.

Other measures may also help stabilize a plasma. For example, the RF control circuit can be used to determine the power delivered to the load (plasma) and may increase or decrease the generator output power to keep the delivered power substantially constant during deposition of a layer.

A gas delivery system 33 provides gases from several sources, 34A-34F chamber for processing the substrate via gas delivery lines 38 (only some of which are shown). As would be understood by a person of skill in the art, the actual sources used for sources 34A-34F and the actual connection of delivery lines 38 to chamber 13 varies depending on the deposition and cleaning processes executed within chamber 13. Gases are introduced into chamber 13 through a gas ring 37 and/or a top nozzle 45. FIG. 4B is a simplified, partial cross-sectional view of chamber 13 showing additional details of gas ring 37.

In one embodiment, first and second gas sources, 34A and 34B, and first and second gas flow controllers, 35A′ and 35B′, provide gas to ring plenum 36 in gas ring 37 via gas delivery lines 38 (only some of which are shown). Gas ring 37 has a plurality of source gas nozzles 39 (only one of which is shown for purposes of illustration) that provide a uniform flow of gas over the substrate. Nozzle length and nozzle angle may be changed to allow tailoring of the uniformity profile and gas utilization efficiency for a particular process within an individual chamber. In a preferred embodiment, gas ring 37 has 12 source gas nozzles made from an aluminum oxide ceramic.

Gas ring 37 also has a plurality of oxidizer gas nozzles 40 (only one of which is shown), which in a preferred embodiment are co-planar with and shorter than source gas nozzles 39, and in one embodiment receive gas from body plenum 41. In some embodiments it is desirable not to mix source gases and oxidizer gases before injecting the gases into chamber 13. In other embodiments, oxidizer gas and source gas may be mixed prior to injecting the gases into chamber 13 by providing apertures (not shown) between body plenum 41 and gas ring plenum 36. In one embodiment, third and fourth gas sources, 34C and 34D, and third and fourth gas flow controllers, 35C and 35D′, provide gas to body plenum via gas delivery lines 38. Additional valves, such as 43B (other valves not shown), may shut off gas from the flow controllers to the chamber.

In embodiments where flammable, toxic, or corrosive gases are used, it may be desirable to eliminate gas remaining in the gas delivery lines after a deposition. This may be accomplished using a 3-way valve, such as valve 43B, to isolate chamber 13 from delivery line 38A and to vent delivery line 38A to vacuum foreline 44, for example. As shown in FIG. 4A, other similar valves, such as 43A and 43C, may be incorporated on other gas delivery lines. Such 3-way valves may be placed as close to chamber 13 as practical, to minimize the volume of the unvented gas delivery line (between the 3-way valve and the chamber). Additionally, two-way (on-off) valves (not shown) may be placed between a mass flow controller (“MFC”) and the chamber or between a gas source and an MFC.

Referring again to FIG. 4A, chamber 13 also has top nozzle 45 and top vent 46. Top nozzle 45 and top vent 46 allow independent control of top and side flows of the gases, which improves film uniformity and allows fine adjustment of the film's deposition and doping parameters. Top vent 46 is an annular opening around top nozzle 45. In one embodiment, first gas source 34A supplies source gas nozzles 39 and top nozzle 45. Source nozzle MFC 35A′ controls the amount of gas delivered to source gas nozzles 39 and top nozzle MFC 35A controls the amount of gas delivered to top gas nozzle 45. Similarly, two MFCs 35B and 35B′ may be used to control the flow of oxygen to both top vent 46 and oxidizer gas nozzles 40 from a single source of oxygen, such as source 34B. The gases supplied to top nozzle 45 and top vent 46 may be kept separate prior to flowing the gases into chamber 13, or the gases may be mixed in top plenum 48 before they flow into chamber 13. Separate sources of the same gas may be used to supply various portions of the chamber.

A remote microwave-generated plasma cleaning system 50 is provided to periodically clean deposition residues from chamber components. The cleaning system includes a remote microwave generator 51 that creates a plasma from a cleaning gas source 34E (e.g., molecular fluorine, nitrogen trifluoride, other fluorocarbons or equivalents) in reactor cavity 53. The reactive species resulting from this plasma are conveyed to chamber 13 through cleaning gas feed port 54 via applicator tube 55. The materials used to contain the cleaning plasma (e.g., cavity 53 and applicator tube 55 ) must be resistant to attack by the plasma. The distance between reactor cavity 53 and feed port 54 should be kept as short as practical, since the concentration of desirable plasma species may decline with distance from reactor cavity 53. Generating the cleaning plasma in a remote cavity allows the use of an efficient microwave generator and does not subject chamber components to the temperature, radiation, or bombardment of the glow discharge that may be present in a plasma formed in situ. Consequently, relatively sensitive components, such as electrostatic chuck 20, do not need to be covered with a dummy wafer or otherwise protected, as may be required with an in situ plasma cleaning process.

System controller 60 controls the operation of system 10. In a preferred embodiment, controller 60 includes a memory 62, such as a hard disk drive, a floppy disk drive (not shown), and a card rack (not shown) coupled to a processor 61. The card rack may contain a single-board computer (SBC) (not shown), analog and digital input/output boards (not shown), interface boards (not shown), and stepper motor controller boards (not shown). The system controller conforms to the Versa Modular European (“VME”) standard, which defines board, card cage, and connector dimensions and types. The VME standard also defines the bus structure as having a 16-bit data bus and 24-bit address bus. System controller 31 operates under the control of a computer program stored on the hard disk drive or through other computer programs, such as programs stored on a removable disk. The computer program dictates, for example, the timing, mixture of gases, RF power levels and other parameters of a particular process. The interface between a user and the system controller is via a monitor, such as a cathode ray tube (“CRT”) 65, and a light pen 66, as depicted in FIG. 4C.

FIG. 4C is an illustration of a portion of an exemplary system user interface used in conjunction with the exemplary CVD processing chamber of FIG. 4A. System controller 60 includes a processor 61 coupled to a computer-readable memory 62. Preferably, memory 62 may be a hard disk drive, but memory 62 may be other kinds of memory, such as ROM, PROM, and others.

System controller 60 operates under the control of a computer program 63 stored in a computer-readable format within memory 62. The computer program dictates the timing, temperatures, gas flows, RF power levels and other parameters of a particular process. The interface between a user and the system controller is via a CRT monitor 65 and a light pen 66, as depicted in FIG. 4C. In a preferred embodiment, two monitors, 65 and 65A, and two light pens, 66 and 66A, are used, one mounted in the clean room wall (65) for the operators and the other behind the wall (65A) for the service technicians. Both monitors simultaneously display the same information, but only one light pen (e.g. 66) is enabled. To select a particular screen or function, the operator touches an area of the display screen and pushes a button (not shown) on the pen. The touched area confirms being selected by the light pen by changing its color or displaying a new menu, for example.

The computer program code can be written in any conventional computer-readable programming language such as 68000 assembly language, C, C++, or Pascal. Suitable program code is entered into a single file, or multiple files, using a conventional text editor and is stored or embodied in a computer-usable medium, such as a memory system of the computer. If the entered code text is in a high level language, the code is compiled, and the resultant compiler code is then linked with an object code of precompiled windows library routines. To execute the linked compiled object code, the system user invokes the object code causing the computer system to load the code in memory. The CPU reads the code from memory and executes the code to perform the tasks identified in the program.

FIG. 4D shows an illustrative block diagram of the hierarchical control structure of computer program 100. A user enters a process set number and process chamber number into a process selector subroutine 110 in response to menus or screens displayed on the CRT monitor by using the light pen interface. The process sets are predetermined sets of process parameters necessary to carry out specified processes, and are identified by predefined set numbers. Process selector subroutine 110 identifies (i) the desired process chamber in a multichamber system, and (ii) the desired set of process parameters needed to operate the process chamber for performing the desired process. The process parameters for performing a specific process relate to conditions such as process gas composition and flow rates, temperature, pressure, plasma conditions such as RF power levels, and chamber dome temperature, and are provided to the user in the form of a recipe. The parameters specified by the recipe are entered utilizing the light pen/CRT monitor interface.

The signals for monitoring the process are provided by the analog and digital input boards of system controller 60, and the signals for controlling the process are output on the analog and digital output boards of system controller 60.

A process sequencer subroutine 120 comprises program code for accepting the identified process chamber and set of process parameters from the process selector subroutine 110 and for controlling operation of the various process chambers. Multiple users can enter process set numbers and process chamber numbers, or a single user can enter multiple process set numbers and process chamber numbers; sequencer subroutine 120 schedules the selected processes in the desired sequence. Preferably, sequencer subroutine 120 includes a program code to perform the steps of (i) monitoring the operation of the process chambers to determine if the chambers are being used, (ii) determining what processes are being carried out in the chambers being used, and (iii) executing the desired process based on availability of a process chamber and type of process to be carried out. Conventional methods of monitoring the process chambers can be used, such as polling. When scheduling which process is to be executed, sequencer subroutine 120 can be designed to take into consideration the “age” of each particular user-entered request, or the present condition of the process chamber being used in comparison with the desired process conditions for a selected process, or any other relevant factor a system programmer desires to include for determining scheduling priorities.

After sequencer subroutine 120 determines which process chamber and process set combination is going to be executed next, sequencer subroutine 120 initiates execution of the process set by passing the particular process set parameters to a chamber manager subroutine 130A-C, which controls multiple processing tasks in chamber 13 and possibly other chambers (not shown) according to the process set sent by sequencer subroutine 120.

Examples of chamber component subroutines are substrate positioning subroutine 340, process gas control subroutine 150, pressure control subroutine 160, and plasma control subroutine 170. Those having ordinary skill in the art will recognize that other chamber control subroutines can be included depending on what processes are selected to be performed in chamber 13. In operation, chamber manager subroutine 130A selectively schedules or calls the process component subroutines in accordance with the particular process set being executed. Chamber manager subroutine 130A schedules process component subroutines in the same manner that sequencer subroutine 120 schedules the process chamber and process set to execute. Typically, chamber manager subroutine 130A includes steps of monitoring the various chamber components, determining which components need to be operated based on the process parameters for the process set to be executed, and causing execution of a chamber component subroutine responsive to the monitoring and determining steps.

Operation of particular chamber component subroutines will now be described with reference to FIGS. 4A and 4D. Substrate positioning subroutine 140 comprises program code for controlling chamber components that are used to load a substrate onto substrate support number 18. Substrate positioning subroutine 140 may also control transfer of a substrate into chamber 13 from, e.g., a plasma-enhanced CVD (“PECVD”) reactor or other reactor in the multi-chamber system, after other processing has been completed.

Process gas control subroutine 150 has program code for controlling process gas composition and flow rates. Subroutine 150 controls the open/close position of the safety shut-off valves and also ramps up/ramps down the mass flow controllers to obtain the desired gas flow rates. All chamber component subroutines, including process gas control subroutine 150, are invoked by chamber manager subroutine 130A. Subroutine 150 receives process parameters from chamber manager subroutine 130A related to the desired gas flow rates.

Typically, process gas control subroutine 150 opens the gas supply lines, and repeatedly (i) reads the necessary mass flow controllers, (ii) compares the readings to the desired flow rates received from chamber manager subroutine 130A, and (iii) adjusts the flow rates of the gas supply lines as necessary. Furthermore, process gas control subroutine 150 may include steps for monitoring the gas flow rates for unsafe rates and for activating the safety shut-off valves when an unsafe condition is detected.

In some processes, an inert gas, such as argon, is flowed into chamber 13 to stabilize the pressure in the chamber before reactive process gases are introduced. For these processes, the process gas control subroutine 150 is programmed to include steps for flowing the inert gas into chamber 13 for an amount of time necessary to stabilize the pressure in the chamber. The steps described above may then be carried out.

Additionally, when a process gas is to be vaporized from a liquid precursor, for example, tetraethylorthosilane (TEOS), the process gas control subroutine 150 may include steps for bubbling a delivery gas such as helium through the liquid precursor in a bubbler assembly or for introducing the helium to a liquid injection valve. For this type of process, the process gas control subroutine 150 regulates the flow of the delivery gas, the pressure in the bubbler, and the bubbler temperature to obtain the desired process gas flow rates. As discussed above, the desired process gas flow rates are transferred to process gas control subroutine 150 as process parameters.

Furthermore, the process gas control subroutine 150 includes steps for obtaining the necessary delivery gas flow rate, bubbler pressure, and bubbler temperature for the desired process gas flow rate by accessing a stored table containing the necessary values for a given process gas flow rate. Once the necessary values are obtained, the delivery gas flow rate, bubbler pressure and bubbler temperature are monitored, compared to the necessary values and adjusted accordingly.

The process gas control subroutine 150 may also control the flow of heat-transfer gas, such as helium (He), through the inner and outer passages in the wafer chuck with an independent helium control (IHC) subroutine (not shown). The gas flow thermally couples the substrate to the chuck. In a typical process, the wafer is heated by the plasma and the chemical reactions that form the layer, and the He cools the substrate through the chuck, which may be water-cooled. This keeps the substrate below a temperature that may damage preexisting features on the substrate.

Pressure control subroutine 160 includes program code for controlling the pressure in chamber 13 by regulating the size of the opening of throttle valve 26 in the exhaust portion of the chamber. There are at least two basic methods of controlling the chamber with the throttle valve. The first method relies on characterizing the chamber pressure as it relates to, among other things, the total process gas flow, the size of the process chamber, and the pumping capacity. The first method sets throttle valve 26 to a fixed position. Setting throttle valve 26 to a fixed position may eventually result in a steady-state pressure.

Alternatively, the chamber pressure may be measured, with a manometer for example, and the position of throttle valve 26 may be adjusted according to pressure control subroutine 360, assuming the control point is within the boundaries set by gas flows and exhaust capacity. The former method may result in quicker chamber pressure changes, as the measurements, comparisons, and calculations associated with the latter method are not invoked. The former method may be desirable where precise control of the chamber pressure is not required, whereas the latter method may be desirable where an accurate, repeatable, and stable pressure is desired, such as during the deposition of a layer.

When pressure control subroutine 160 is invoked, the desired, or target, pressure level is received as a parameter from chamber manager subroutine 130A. Pressure control subroutine 160 measures the pressure in chamber 13 by reading one or more conventional pressure manometers connected to the chamber; compares the measured value(s) to the target pressure; obtains proportional, integral, and differential (PID) values from a stored pressure table corresponding to the target pressure, and adjusts throttle valve 26 according to the PID values obtained from the pressure table. Alternatively, pressure control subroutine 160 may open or close throttle valve 26 to a particular opening size to regulate the pressure in chamber 13 to a desired pressure or pressure range.

Plasma control subroutine 170 comprises program code for controlling the frequency and power output setting of RF generators 32A and 32B and for tuning matching networks 32A and 32B. Plasma control subroutine 370, like the previously described chamber component subroutines, is invoked by chamber manager subroutine 330A.

An example of a system that may incorporate some or all of the subsystems and routines described above would be the ULTIMA™ system, manufactured by APPLIED MATERIALS, INC., of Santa Clara, Calif., configured to practice the present invention. Further details of such a system are disclosed in the copending, commonly assigned U.S. patent application Ser. No. 08/679,927, filed Jul. 15, 1996, entitled “Symmetric Tunable Inductively-Coupled HDP-CVD Reactor,” having Fred C. Redeker, Farhad Moghadam, Hirogi Hanawa, Tetsuya Ishikawa, Dan Maydan, Shijian Li, Brian Lue, Robert Steger, Yaxin Wang, Manus Wong and Ashok Sinha listed as co-inventors, the disclosure of which is incorporated herein by reference. The described system is for exemplary purpose only. It would be a matter of routine skill for a person of skill in the art to select an appropriate conventional substrate processing system and computer control system to implement the present invention.

The system described above is generally suitable for performing high-density plasma deposition using a chemical-vapor deposition process. Other high-density plasma techniques that may be used alternatively will be evident to those of skill in the art. For example, in one embodiment, a high-density plasma electron-cyclotron resonance (HDP-ECR) technique is used. Such a technique couples power electromagnetically to produce the high-density plasma. One embodiment of an HDP-ECR device is described in, for example, U.S. Pat. No. 4,948,458, entitled “Method and apparatus for producing magnetically-coupled planar plasma,” issued to Ogle on Aug. 14, 1990, the entire disclosure of which is herein incorporated by reference for all purposes.

3. Formation of an Optical Waveguide Structure

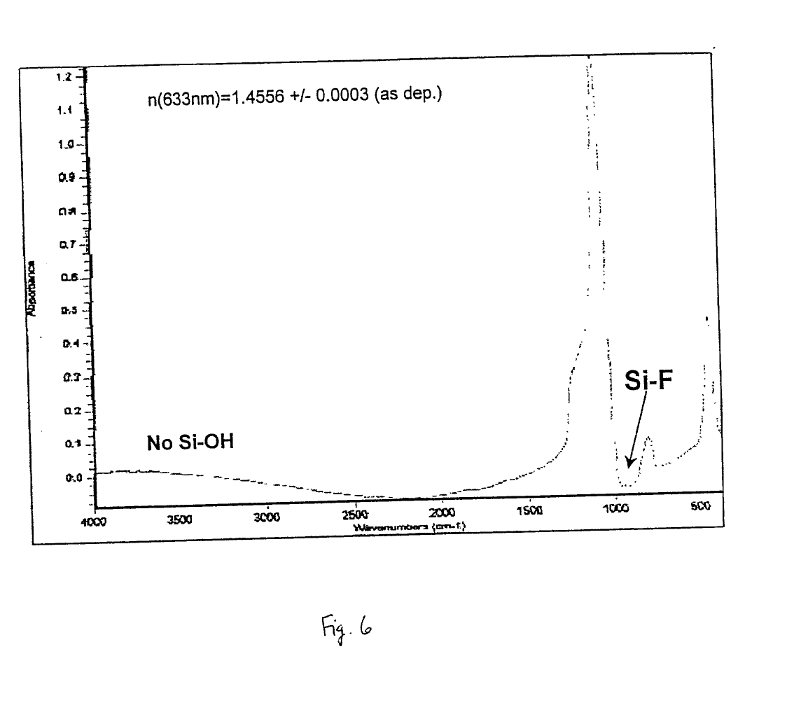

FIG. 5 shows one embodiment in which an optical waveguide structure, such as shown in FIG. 3, may be formed. The process starts at block 504 and an undercladding layer 7a is deposited over the substrate 6 at block 508. Such deposition may be performed by any suitable method, including for example by deposition with a CVD (including PECVD and HDP-CVD) technique. At block 516, the cores 8 are formed on the undercladding layer. Typically, cores 8 are formed by depositing a core layer, which is subsequently patterned and etched to produce a plurality of discrete core structures. The cores may be deposited, for example, in accordance with commonly assigned and concurrently filed U.S. Pat. Appl. No. ______ entitled “METHOD OF MANUFACTURING AN OPTICAL CORE,” by Hichem M'Saad (Attorney Docket Number A6123/T43700), the entire disclosure of which has been incorporated by reference. At block 520, the uppercladding layer 7b is then deposited over the cores 8 with a high-density plasma, i.e. a plasma having an ion density that is equal to or exceeds 10¹¹ ions/cm³. In one embodiment, the HDP uppercladding layer is deposited in one pass, while in other embodiments, a multiple-pass approach is used. In those embodiments that use a multiple-pass approach, the chamber 13 is typically dry-cleaned after each pass. Such an embodiment may be suitable, for example, for applications requiring a greater total thickness for the layer.

In one embodiment, deposition of the uppercladding layer at block 520 uses O₂, SiH₄, and SiF₄ as precursor gases, which are flowed into the chamber 13 for deposition with a high-density plasma. In a particular embodiment, the ratio of flow rates for O₂ to SiH₄ is greater than 1.8:1 to achieve good refractive index uniformity. In addition, an inert gas such as Ar may also be flowed with the precursor gases. Alternative inert gases that may also be used include He, Ne, Kr, and Xe. The SiF₄ provides fluorine dopants to produce as FSG layer. In alternative embodiments, other dopants may be substituted or added. For example, a source of phosphorus such as PH₃ or a combined fluorine-boron source such as BF₃ may be used. The use of phosphorus dopants will tend to reduce the stress of the uppercladding layer as deposited and the use of boron will tend both to reduce the stress and also to affect the refractive index of the uppercladding layer. Application of an RF bias during the process not only affects the deposition efficiency and allows gapfill of aspect ratios as high as 7:1 for gap separations of 1 μm, but also increases the temperature of the substrate through heat load to the substrate. The substrate is typically not cooled, since higher temperature provides lower impurity incorporation. As a result, the deposition temperature is approximately 600-700° C. The pressure in the chamber 13 during deposition is typically less than 12 mtorr.

Blocks 524 and 528 of FIG. 5 show additional optional aspects of the method that may be used. At block 524, a deposition/etching/deposition (“dep/etch/dep”) process is used to improve the gapfill characteristics of the uppercladding layer 7b between the cores 8. A dep/etch/dep process used with high-density plasma processes cycles the chemistry between deposition and etching phases. The intermediate etching phase has the effect of reopening the gap between the cores to prevent the formation of voids that would otherwise result from the characteristic breadloafing shape produced as material is deposited. In one embodiment, the etchant gas used to perform the etching comprises NF₃. A more complete description of dep/etch/dep processes as applied to high-density plasma processes is described in the copending, commonly assigned U.S. Ser. No. 09/648,395, filed Aug. 24, 2000 in the names of Michael Kwan and Eric Liu, entitled “GAS CHEMISTRY CYCLING TO ACHIEVE HIGH ASPECT RATIO GAPFILL WITH HDP-CVD,” the entire disclosure of which is herein incorporated by reference.

At block 528, a second uppercladding layer is deposited with PECVD. Such an embodiment may be particularly useful where it is desirable to reduce cost and still take advantage of certain aspects of the invention. In such an embodiment, the HDP process is used principally for gapfill between the cores. The HDP process is used to deposit the uppercladding layer 7b at block 520 up to, for example, approximately 75% of the height of the cores 8. The actual thickness of the HDP-deposited uppercladding layer will depend on the core height and aspect ratio of the gaps between the cores 8. Subsequently, the PECVD oxide is deposited as the second uppercladding layer, although in such an embodiment, the refractive index of the PECVD oxide should be matched with the refractive index of the HDP-deposited portion. Generally in such an embodiment, a post-PECVD-deposition anneal is necessary, thereby also requiring that the refractive index of the HDP-deposited portion be approximately 0.03% higher because how its properties will be affected during such an anneal.

A further optional aspect of the method, which may be used whether the uppercladding layer 7b is deposited as a single layer or as multiple layers, comprises planarization of the deposited uppercladding layer 7b. In one embodiment, planarization is achieved with chemical mechanical polishing (“CMP”). After the uppercladding layer is planarized, the formation of the waveguide is completed using steps that are well known to those of skill in the art.

Suitable process parameters for deposition of the uppercladding layer according to one embodiment of the invention are summarized in the following table:

TABLE

| Process Parameter | Range | Value |
|---|---|---|
| F(SiH₄)(sccm) | 80-110 | 100 |
| F(O₂)(sccm) | ≧175 | 258 |
| F(O₂)/F(SiH₄) | >1.8 | 25.8 |
| F(SiF₄)(sccm) | 10-20 | 18 |
| F(SiF₄)/F(SiH₄) | 0.125-0.180 | 0.180 |
| F(PH₃)(sccm) | 0-30 | NA |
| F(PH₃)/(F(PH₃) + F(SiH₄) ) | 0-0.27 | NA |
| E(BF₃)(sccm) | 0-20 | NA |
| F(BF₃)/(F(BF₃) + F(SiH₄) ) | 0-0.2 | NA |
| F(Ar)(seem) - Top | 0-50 | 12 |
| F(Ar)(sccm) - Side | 0-150 | 78 |
| Source RF Density - Top (Watts/cm²) | 2.5-5.5 | 4 |
| Source RF Density - Side (Watts/cm²) | 7.5-12 | 10 |
| Bias RF Density (Watts/cm²) | 0-16 | 0 |
| Pressure (millitorr) | <100 | 10 |
| Dome Temp | NA | 125 |
| Chuck | NA | OFF |

In many embodiments that use such parameters, the deposition rate is greater than about 5 k Å/min and the refractive-index uniformity is as low as ±0.0001. In HDP processes, deposition and sputtering occur simultaneously and the table accordingly characterizes the process with the deposition-sputter ratio D/S:

$$\frac{D}{S} ≡ \frac{\text{(net deposition rate)} + \text{(blanket sputtering rate)}}{\text{(blanket sputtering rate)}} .$$

This ratio increases with increased deposition and decreases with increased sputtering.

As used in the definition of D/S, the “net deposition rate” refers to the deposition rate that is measured when deposition and sputtering are occurring simultaneously. The “blanket sputter rate,” however, refers to the sputter rate measured when the process recipe is run without deposition gases; the servo pressure is adjusted to the deposition pressure and the sputter rate is measured on a blanket thermal oxide. For example, process parameters for deposition of the uppercladding layer according to embodiments of the invention shown in the above table may result in values of D/S between 3 and 10.

It is to be understood that recipe present in the Tables above may be scaled to larger substrates by multiplying each parameter, except power density the ratios, by a scaling factor. For example, to scale from 200 mm to 300 mm, a scaling factor of approximately 2.25 may be used. Also, a person skilled in the art will recognize that these values are in part chamber specific. Gas flow rates, RF power levels, and other variables set forth herein have been determined for an ULTIMA™ system, manufactured by APPLIED MATERIALS, INC., of Santa Clara, Calif., and configured for 200 mm substrates. These values may differ for chambers of other design and/or volume.

4. Experimental Results

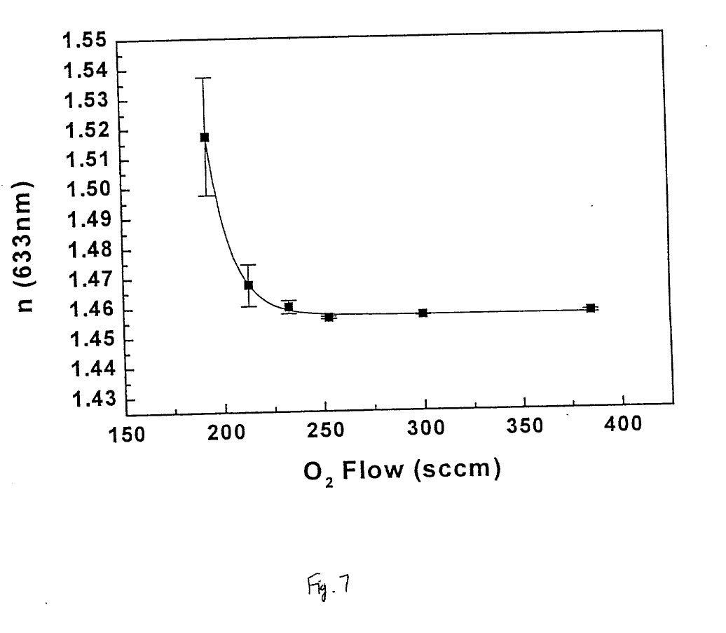

A number of experiments have been performed to assess and characterize the effectiveness of embodiments of the invention in producing the desired physical properties for the uppercladding layer. Results from such experiments are presented in FIGS. 6-9.

In FIG. 6, the F dopant and H impurity levels are examined with a Fourier-transform infrared (“FTIR”) spectral analysis of an uppercladding layer deposited according to the embodiment described above. The flow rate of SiH₄ was about 100 sccm, the flow rate of O₂ was about 250 sccm, the flow of SiF₄ was about 20 sccm, and the flow rate of Ar was about 150 sccm. The resulting layer had a refractive index at 633 nm of 1.4556±0.0003, within the desired range. In the FTIR spectral results, the peak at about 980 cm⁻¹ corresponds to Si-F and shows the presence of fluorine dopants in the film. By contrast, the lack of a Si-OH peak near 3400 cm⁻¹ shows that the level of H contamination in the film is small. This low contamination level is corroborated by the annealing results shown in FIG. 9.

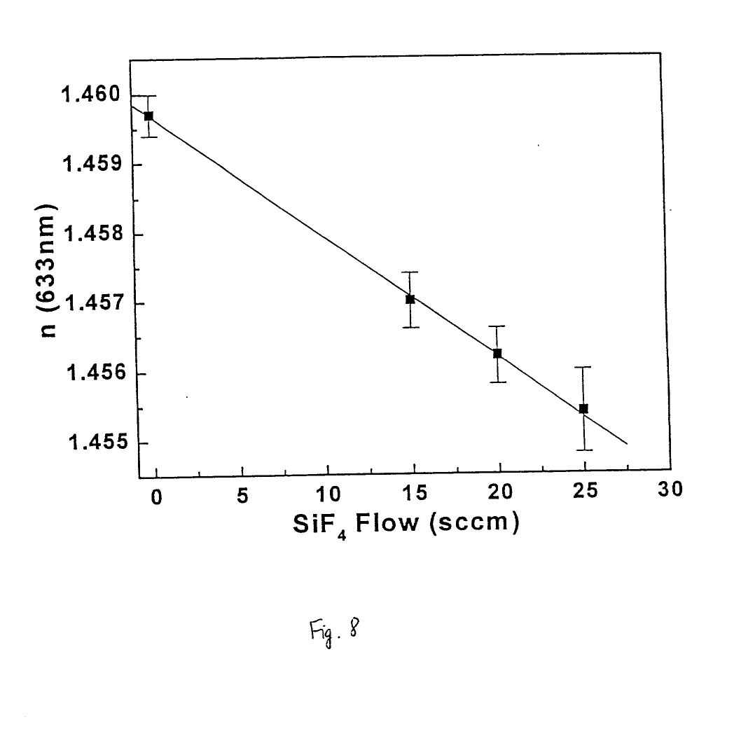

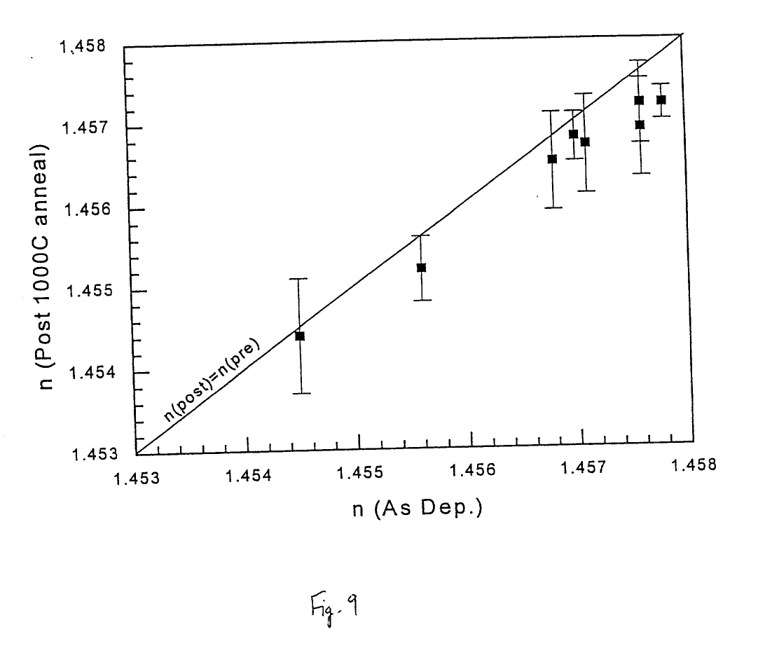

In FIGS. 7 and 8, the effect of changing the O₂ and SiF₄ flow rates is shown. FIG. 7 shows results on the refractive index as a function of changing the O₂ flow rate relative to the SiH4 flow rate. If the process gas is oxygen-deficient, the refractive index is too high and the nonuniformity of the refractive index is increased, so that the flow ratio F(O₂)/F(SiH₄) should be maintained>1.8.

FIG. 8 shows a similar effect of changing the SiF₄ flow rate with the other parameters fixed. The addition of fluorine dopants to the uppercladding layer causes a decrease in the refractive index so that the process may be tuned to provide the desired refractive index.

FIG. 9 shows the effect of performing an annealing process on the deposited uppercladding layer. The ordinate plots the refractive index of the film after annealing as a function of the refractive index before annealing on the abscissa. The anneal was performed at 1000° C. for two hours. For comparative purposes, a solid line plots the position of results having no change as a result of the annealing. The actual experimental results show that the refractive index tends to decrease slightly as a result of the anneal, but is less than 0.03%. Accordingly, no anneal of an uppercladding layer deposited in accordance with embodiments of the invention is required.

After reading the above description, other variations will be apparent to those of skill in the art without departing from the spirit of the invention. These equivalents and alternatives are intended to be included within the scope of the present invention. Therefore, the scope of this invention should not be limited to the embodiments described, but should instead be defined by the following claims.

What is claimed is:

1. A method for forming an optical waveguide on a substrate in a process chamber, the method comprising:
depositing an undercladding layer over the substrate;
forming at least one core over the undercladding layer; and
depositing an uppercladding layer over the at least one core with a high-density plasma process.

2. The method recited in claim 1 wherein depositing the uppercladding layer comprises:
flowing an oxygen-containing gas and a silicon-containing gas into the process chamber to produce a gaseous mixture;
generating a high-density plasma from the gaseous mixture; and
depositing a silicate glass layer over the at least one core with the high-density plasma.

3. The method recited in claim 2 wherein a flow rate of the oxygen-containing gas is more than 1.8 times a flow rate of the silicon-containing gas.

4. The method recited in claim 3 wherein the flow rate of the oxygen-containing gas is greater than 175 sccm and the flow rate of the silicon containing gas is between 80 and 110 sccm.

5. The method recited in claim 4 wherein the oxygen-containing gas comprises O₂ and the silicon-containing gas comprises SiH₄.

6. The method recited in claim 2 wherein depositing the uppercladding layer further comprises flowing an inert gas into the process chamber with a flow rate between 0 and 200 sccm.

7. The method recited in claim 2 wherein depositing the uppercladding layer further comprises flowing a fluorine-containing gas into the process chamber with a flow rate between 10 and 20 sccm.

8. The method recited in claim 7 wherein the fluorine-containing gas comprises SiF₄.

9. The method recited in claim 2 wherein depositing the uppercladding layer further comprises flowing a phosphorus-containing gas into the process chamber with a flow rate between 0 and 30 sccm.

10. The method recited in claim 9 wherein the phosphorus-containing gas comprises PH₃.

11. The method recited in claim 2 wherein depositing the uppercladding layer further comprises flowing a boron-containing gas into the process chamber with a flow rate between 0 and 20 sccm.

12. The method recited in claim 11 wherein the boron-containing gas comprises BF₃.

13. The method recited in claim 2 further comprising applying an RF source power to the process chamber, the RF source power having a power density between 6 and 30 W/cm².

14. The method recited in claim 2 further comprising applying an RF bias power to the substrate, the RF bias power having a power density between 0 and 16 W/cm².

15. The method recited in claim 2 wherein depositing the silicate glass layer comprises depositing the silicate glass layer at a pressure less than 12 mtorr.

16. The method recited in claim 1 wherein depositing the uppercladding layer comprises:
flowing O₂ into the process chamber with a flow rate greater than 175 sccm;
flowing SiH₄ into the process chamber with a flow rate between 80 and 110 sccm such that a ratio of the O₂ flow rate to the SiH₄ flow rate is greater than 1.8,
flowing SiF₄ into the process chamber with a flow rate between 10 and 20 sccm;
flowing Ar into the process chamber with a flow rate between 0 and 200 sccm;
generating a high-density plasma from the gases flowed into the process chamber; and
applying an RF bias power to the substrate, the RF bias power having a power density between 0 and 16 W/cm².

17. The method recited in claim 1 wherein forming at least one core over the undercladding layer comprises forming a plurality of cores over the undercladding layer, the method further comprising:
etching a portion of the uppercladding layer in gaps between the plurality of cores; and
depositing a second uppercladding layer over the etched undercladding layer.

18. The method recited in claim 1 wherein the high-density plasma process comprises a high-density plasma electron-cyclotron-resonance process.

19. The method recited in claim 1 further comprising depositing a second uppercladding layer over the uppercladding layer with a plasma-enhanced chemical-vapor deposition process.

20. The method recited in claim 1 wherein the uppercladding layer has a refractive index between about 1.4443 and 1.4473 at a wavelength of 1550 nm.

21. An optical waveguide made according to the method recited in claim 20.

22. An optical waveguide made according to the method recited in claim 1.

23. A method for forming an optical waveguide on a substrate in a process chamber, the method comprising:
depositing an undercladding layer over the substrate;
forming at least one core over the undercladding layer;
depositing an uppercladding layer over the at least one core using a high-density plasma CVD process; and
thereafter, completing formation of the optical waveguide without thermally annealing the uppecladding layer.

24. The method recited in claim 23 wherein the uppercladding layer comprises a fluorinated silicate glass layer.

25. A computer-readable storage medium having a computer-readable program embodied therein for directing operation of a substrate processing system including a process chamber; a plasma generation system; a substrate holder; and a gas delivery system configured to introduce gases into the process chamber, the computer-readable program including instructions for operating the substrate processing system to form an optical waveguide on a substrate disposed in the processing chamber in accordance with the following:
depositing an undercladding layer over the substrate;
forming at least one core over the undercladding layer;
flowing an oxygen-containing gas, a silicon-containing gas, and a fluorine-containing gas into the process chamber to produce a gaseous mixture;
generating a high-density plasma from the gaseous mixture; and
depositing a fluorinated silicate glass uppercladding layer over the at least one core.

26. The computer-readable storage medium recited in claim 25 wherein a flow rate of the oxygen-containing gas is at least 1.8 times as large as a flow rate of the silicon-containing gas.

27. A substrate processing system comprising:
a housing defining a process chamber;
a high-density plasma generating system operatively coupled to the process chamber;
a substrate holder configured to hold a substrate during substrate processing;
a gas-delivery system configured to introduce gases into the process chamber, including sources for a silicon-containing gas, a fluorine-containing gas, and an oxygen-containing gas;
a pressure-control system for maintaining a selected pressure within the process chamber;
a controller for controlling the high-density plasma generating system, the gas-delivery system, and the pressure-control system; and
a memory coupled to the controller, the memory comprising a computer-readable medium having a computer-readable program embodied therein for directing operation of the substrate processing system to form an optical waveguide on a substrate, the computer-readable program including
instructions to deposit an undercladding layer over the substrate;
instructions to form at least one core over the undercladding layer;
instructions to flow a gaseous mixture containing flows of the silicon-containing gas, the fluorine-containing gas, the nitrogen-containing gas, and the oxygen-containing gas;
instructions to generate a high-density plasma from the gaseous mixture and to apply a bias to the substrate; and
instructions to deposit a fluorinated silicate glass layer onto the substrate using the high-density plasma.

28. The substrate processing system recited in claim 27 wherein a flow rate of the oxygen-containing gas is at least 1.8 times as large as a flow rate of the silicon-containing gas.
